(19) United States
(12) Patent Application Publication
(10) Pub. No.: US 2016/0027287 A1
(43) Pub. Date: Jan. 28, 2016

(54) IDENTIFICATION SYSTEM

(71) Applicant: Tokyo Electron Limited, Tokyo (JP)

(72) Inventor: Adrian Marshall, Horsham (GB)

(21) Appl. No.: 14/807,088

(22) Filed: Jul. 23, 2015

(30) Foreign Application Priority Data
Jul. 25, 2014 (GB) 1413219.5

(51) Int. Cl. G08B 21/18

(52) U.S. Cl. CPC G08B 21/187

(57) ABSTRACT

Disclosed herein are systems and methods for identifying components of a system that may be used to treat microelectronic substrates. The components may not reside at the same location and may be out of visual range, such that technicians working on one system may not be able to distinguish the components of that system from other similar systems on manufacturing floor. In one embodiment, the components of the system may include status indicator lights that may indicate a common system status to enable the identification of the related components.

The present invention relates to an identification system for semiconductor production equipment.

It is common for a semiconductor production machine to include several different interconnected elements which are housed over multiple floors and for different elements of the same machine to be housed remote from each other; for example, on different floors. The most important elements are housed in a “clean room” on one floor and the less important elements are housed in a “sub fab” on a different floor. Such a multi-element machine may include a Main System connected to several auxiliary elements (e.g. cabinets) and an AC Power Box. The Main System is typically housed in a clean room together with one or more auxiliary elements. The AC Power Box and other auxiliary elements are typically housed in the sub fab.

Conditions in a “clean room” are carefully controlled to prevent any contamination of and damage to the devices being manufactured. It is common for space in a clean room to be severely restricted, such that the semiconductor production equipment is housed in a very confined space. Engineers installing, refurbishing and servicing semiconductor production machines work under difficult conditions because the layout of the equipment in such a confined space is very complex. Similar problems are faced in the sub fab due to a large number of machine elements belonging to a large number of different machines which are all housed together in a large and complex layout.

In order for an engineer to follow the complex layout they need to follow a “map” of the machine elements and carefully note relevant serial numbers or other similar labelling to link different elements of the same machine. This is problematic because it is usual for a large number of such multi-element machines to be provided within the same building and so it is not an easy task to correctly identify which elements in the sub fab are interconnected with which Main System or element in the clean room.

Positioning of equipment is not always clearly defined and it is common for errors to be made by engineers in relation to the equipment layout. This can be particularly problematic when a multi-element machine is to be shut down. In these situations, it is common for an engineer to shut down the wrong machine because they mistakenly identify an element of a different machine and so turn off that machine instead. Existing solutions to minimize such errors are to provide further training, which is costly in terms of expense and time taken. Alternatively, engineers may work in a buddy system to reduce the risk of human error occurring, but this decreases the efficiency of repair/servicing and increases the time taken for engineering tasks.

Semiconductor production equipment is expensive and is used in the manufacture of a high value product. Thus, any “downtime” during production needs to be minimized and any unnecessary shut-down of production is very expensive. If a machine is incorrectly stopped during production it is likely to take some time before production can be re-started and thus commercial losses due to the downtime are significant. This is particularly the case in the event that a machine is incorrectly shut down and a near finalized batch of high value product is damaged.

Furthermore, any unnecessary shut-down wastes power in unnecessarily having to re-start a machine, increasing the cost and environmental impact of production.

The present invention sets out to provide an identification system which alleviates the problems described above to provide an improved system that reduces the risk of unnecessarily shutting down production.

In one aspect, the present invention provides an identification system for a semiconductor manufacturing machine, the machine comprising a main element associated with one or more auxiliary elements, wherein the identification system comprises one or more indicators provided on one or more of the auxiliary elements for indicating that an auxiliary element is associated with the main element of the machine, wherein, in use, said one or more indicators are activated when a trigger is activated on the main element.

In this way, it will be appreciated that the indicators are only activated when a trigger is activated on the main system. Accordingly, in a situation wherein a plurality of multi-element machines are provided together with different elements of different machines being provided on different floors of a building, when the trigger on the main element of the machine is activated the indicators allow quick and easy identification of the auxiliary elements interconnected with the main element. This greatly reduces the possibility for the wrong auxiliary element to be shut down which in turn would shut down the wrong machine.

Preferably, one or more of the auxiliary elements are housed remotely from the main element.

Preferably, the main element is housed on one floor of a building and one or more of the auxiliary elements are housed on a different floor of the building.

Preferably, the main element is provided within a restricted zone and one or more of the auxiliary elements are provided outside the restricted zone.

Preferably, the restricted zone is a clean room.

Preferably, one or more indicators are provided on the main element wherein said one or more indicators on the main element are also activated by the trigger on the main element.

Preferably, all of the auxiliary elements comprise one or more of said indicators.

Preferably, the one or more auxiliary elements comprise a power source for the machine.

Preferably, the one or more indicators comprise a visual indicator.

Preferably, the visual indicator comprises at least one light emitting means.

Preferably, the visual indicator comprises a flashing light emitting means.

Preferably, one or more of the indicators are integral with an emergency stop device.

Preferably, the emergency stop device is an emergency off button (EMO).

Preferably, the trigger is for powering down the main element and/or placing the main element in a non-production mode.

Preferably, the trigger comprises a switch for placing the main element in a non-production mode.

Preferably, the trigger comprises computer software for placing the main element in a non-production mode.

Preferably, the trigger comprises a switch for powering down the main element.

Preferably, the trigger comprises computer software for powering down the main element.

Preferably, the trigger is for switching off the main element. Preferably, each of the auxiliary elements comprises an indicator.

Preferably, the main element and each of the auxiliary elements comprise an indicator.

Preferably, each of the auxiliary elements comprises an emergency stop device.

Preferably, the main element and each of the auxiliary elements comprise an emergency stop device.

Preferably, the emergency stop devices are linked such that when an emergency stop device of one element is activated, all elements of the machine are shut down.

Preferably, each emergency stop device comprises an indicator.

Preferably, the one or more auxiliary elements comprise a power source for the machine comprising a flashing beacon.

In a particularly preferred embodiment of the invention, there is provided an identification system for a semiconductor manufacturing machine, the machine comprising a main element associated with one or more auxiliary elements, the main element being housed remotely from one or more of the auxiliary elements, wherein the identification system comprises an indicator on each of the auxiliary elements for indicating that an auxiliary element is associated with the main element of the machine, wherein, in use, said indicators are activated when a trigger is activated on the main element, said trigger also activating an indicator on the main element.

Preferably, the indicators comprise a flashing emergency off button on the main element and on each of the auxiliary elements.

Preferably, the trigger is for powering down the main element and/or placing the main element in a non-production mode.

Preferably, the trigger comprises a switch for powering down the main element.

Preferably, the trigger comprises computer software for powering down the main element.

Preferably, the trigger comprises a switch for placing the main element in a non-production mode.

Preferably, the trigger comprises computer software for placing the main element in a non-production mode.

Preferably, the trigger is for switching off the main element.

According to another aspect of the present invention, there is provided a semiconductor production machine comprising a main element associated with one or more auxiliary elements, wherein one or more of the auxiliary elements comprise an indicator for indicating that the auxiliary element is associated with the main element, wherein, in use, the indicators are activated when a trigger is activated on the main element.

In a particularly preferred embodiment, there is provided a semiconductor manufacturing machine comprising a main element associated with one or more auxiliary elements, the main element being housed remotely from one or more of the auxiliary elements, wherein each of the auxiliary elements comprises an indicator for indicating that the auxiliary element is associated with the main element of the machine, wherein, in use, the indicators are activated when a trigger is activated on the main element, said trigger also activating an indicator on the main element.

For the purposes of clarity and a concise description, features are described herein as part of the same or separate embodiments; however it will be appreciated that the scope of the invention may include embodiments having combinations of all or some of the features described. For example, it will be appreciated that all preferred features of the identification systems described herein are equally applicable to the semiconductor manufacturing machines described herein, and vice versa.

The invention will now be described by way of example with reference to the accompanying diagrammatic drawings, in which:

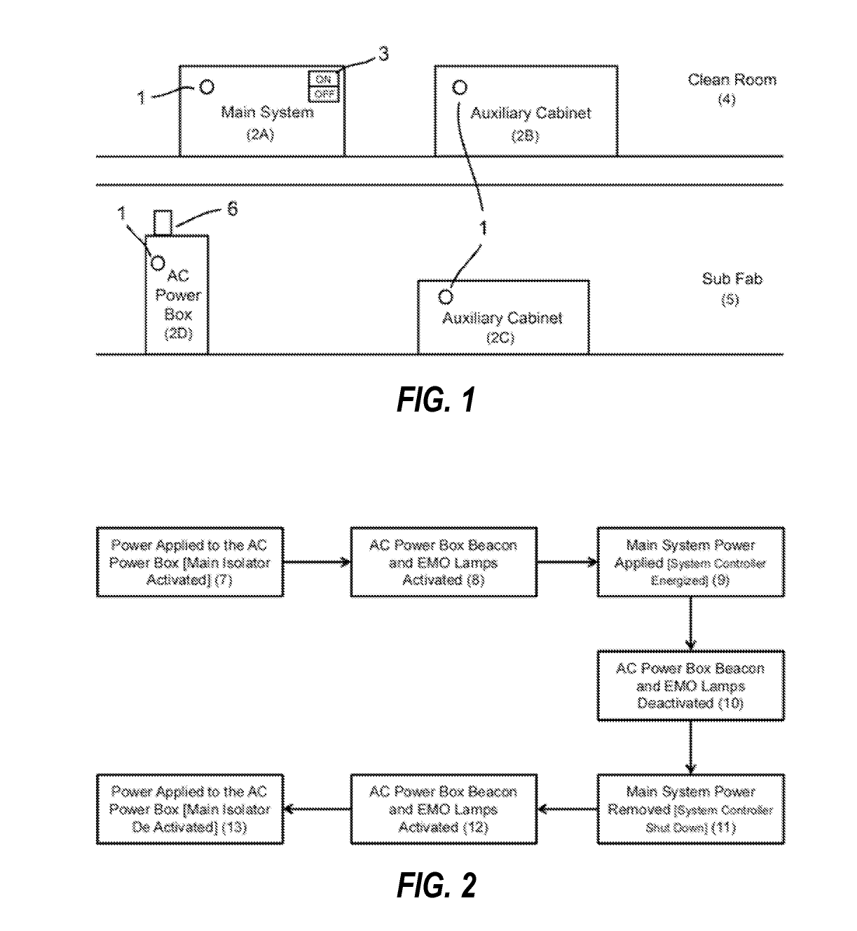

FIG. 1 is a schematic plan view of a semiconductor production machine of the present invention;

FIG. 2 is a flow diagram of a preferred embodiment of how the present invention functions in use; and

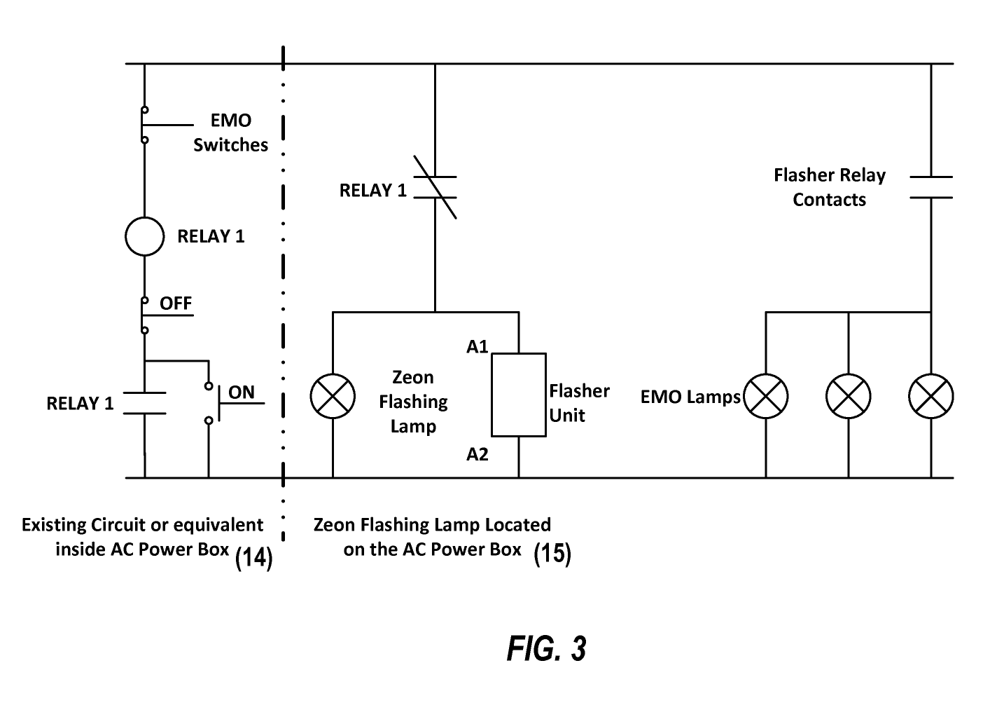

FIG. 3 is an example circuit diagram demonstrating the identification system of the present invention retro-fitted to an existing semiconductor production machine.

Referring to FIG. 1, there is shown a semiconductor manufacturing machine which comprises a main element 2A (Main System), first and second auxiliary elements 2B, 2C (Auxiliary Cabinets) and third auxiliary element 2D (AC Power Box).

The third auxiliary element 2D takes the form of a power source (AC Power Box) for the machine. The main element 2A and first auxiliary element 2B are provided in a “clean room” 4 in a first area of production. The clean room is a restricted zone where the environment is carefully controlled to eliminate the risk of contaminants entering therein. The second and third auxiliary elements, 2C, 2D are provided in a different “sub fab” area in a second area of production. It will be appreciated that the second and third auxiliary elements 2C, 2D could be provided on a different floor of the building in which the machine is housed, such that the main element 2A and auxiliary elements 2C, 2D are positioned in locations remote from one another.

The main element 2A and each of the auxiliary elements 2B, 2C, 2D comprise an emergency stop/off (EMO) button 1, or other user interface, such as a switch. The emergency stop/off button is clearly visible to a user and houses an integral visual indicator in the form of one or a plurality of light emitting means. When one of the EMO buttons is pressed this causes all elements 2A, 2B, 2C, 2D of the machine to shut down.

The main element 2A comprises a trigger 3 in the form of an on/off switch 3 for powering down the Main System and so placing the machine in a state suitable for testing, maintenance or repair. Instead of an on/off switch, the Main System can also be powered down via computer software. It is often desirable to test correct functioning of the EMO buttons and so the computer of the main element is switched off before this is done in order to prevent damage to the software and hardware provided in the main element.

When the on/off switch 3 is pressed, this causes the EMOs 1 on the main element (Main System) and the EMOs 1 on the auxiliary elements (Auxiliary Cabinets 2B, 2C and AC Power Box 2D) to flash. This, therefore, provides a clear visual indicator to an engineer as to which elements provided in the various locations around the building are linked as one machine.

Testing of the EMO buttons 1 without the indication system of the present invention requires an engineer to firstly press the on/off switch on the main element 2A of the machine to be tested and to then take a note of a serial number provided on the main element 2A. Whilst corresponding serial numbers are provided on the auxiliary elements of the machine and whilst the engineer should, in theory, be able to match the serial number for each auxiliary element and test the correct EMO button, this is an area where mistakes are commonly made and the wrong EMO button is pressed resulting in costly downtime or, worse still, damage to high value product nearing completion.

The identification system of the present invention clearly identifies all elements of the machine irrespective of where they are located and so this greatly minimizes the risk of mistakes being made.

In addition to flashing of the EMO button 1, a flashing beacon 6 can be provided on one or more of the auxiliary elements. For example, as shown in FIG. 1, a flashing beacon 6 is provided on the AC Power Box 2D.

Referring to FIG. 2, there is shown a flow diagram demonstrating how an example embodiment of the identification system works. In normal operation, power is applied to an AC Power Box and the main isolator is activated (7). This activates the flashing beacon on the AC Power Box and the flashing EMO buttons on the Main System and auxiliary elements (8). The Main System power is then applied by switching on the Main System computer (energizing the system controller) (9) which then deactivates (10) the flashing beacon on the AC Power Box and the flashing EMOs on the Main System and auxiliary elements. When the Main System is powered down (11), this causes activation (12) of the flashing beacon on the AC Power Box and the flashing EMOs on the Main System and auxiliary elements. EMO buttons can then be tested without fear of pressing the wrong one. When testing has been completed and the machine is ready to be switched back on, the main isolator is activated (13).

Referring to FIG. 3, a circuit diagram is shown in which the identification system of the present invention can be retro-fitted to an existing system 14 (to the left of the broken line), with additional circuitry 15 provided to connect the EMO switches to EMO flashing lights (to the right of the broken line).

The above described embodiment has been given by way of example only, and the skilled reader will naturally appreciate that many variations could be made thereto without departing from the scope of the claims.

1. An identification system for a semiconductor manufacturing machine, the machine comprising a main element associated with one or more auxiliary elements, wherein the identification system comprises one or more indicators provided on one or more of the auxiliary elements for indicating that an auxiliary element is associated with the main element of the machine, wherein, in use, said one or more indicators are activated when a trigger is activated on the main element, wherein the trigger comprises powering down the main element.

2. The identification system of claim 1, wherein one or more of the auxiliary elements are housed remotely from the main element.

3. The identification system of claim 2, wherein the main element is housed on one floor of a building and one or more of the auxiliary elements are housed on a different floor of the building.

4. The identification system of claim 3, wherein the main element is provided within a restricted zone and one or more of the auxiliary elements are provided outside the restricted zone.

5. The identification system of claim 4, wherein the restricted zone is a clean room.

6. The identification system of claim 1, wherein one or more indicators are provided on the main element and wherein said one or more indicators on the main element are also activated by the trigger on the main element.

7. The identification system of claim 1, wherein the one or more auxiliary elements comprise a power source for the machine.

8. The identification system of claim 1, wherein the one or more indicators comprise a visual indicator.

9. The identification system of claim 8, wherein the visual indicator comprises at least one light emitting means.

10. The identification system of claim 9, wherein the visual indicator comprises a flashing light emitting means.

11. The identification system of claim 1, wherein one or more of the indicators are integral with an emergency stop device.

12. The identification system of claim 11, wherein the emergency stop device is an emergency off button (EMO).

13. The identification system of claim 1, wherein the trigger comprises (i) a switch for powering down the main element and/or placing the main element in a non-production mode; and/or (ii) computer software for powering down the main element and/or placing the main element in a non-production mode.

14. The identification system of claim 1, wherein each of the auxiliary elements comprises an indicator.

15. The identification system of claim 1, wherein the main element and each of the auxiliary elements comprise an indicator.

16. The identification system of claim 1, wherein each of the auxiliary elements comprise an emergency stop device.

17. The identification system of claim 1, wherein the main element and each of the auxiliary elements comprise an emergency stop device.

18. The identification system of claim 17, wherein the emergency stop devices are linked such that when an emergency stop device of one element is activated, all elements of the machine are shut down.

19. The identification system of claim 18, wherein each emergency stop device comprises an indicator.

20. The identification system of claim 1, wherein the one or more auxiliary elements comprise a power source for the machine comprising a flashing beacon.
